(19) United States
(12) Patent Application Publication
(10) Pub. No.: US 2018/0298611 A1
(43) Pub. Date: Oct. 18, 2018

(54) Configurable Hydronic Structural Panel

(71) Applicants: David R. Hall, Provo, UT (US); Joe Fox, Spanish Fork, UT (US); Benjamin Jensen, Orem, UT (US); David Lundgreen, Spanish Fork, UT (US); Seth Myer, Eagle Mtn., UT (US)

(72) Inventors: David R. Hall, Provo, UT (US); Joe Fox, Spanish Fork, UT (US); Benjamin Jensen, Orem, UT (US); David Lundgreen, Spanish Fork, UT (US); Seth Myer, Eagle Mtn., UT (US)

(21) Appl. No.: 15/489,279

(22) Filed: Apr. 17, 2017

(51) Int. Cl. E04C 2/52; E04B 1/94; F24D 3/14; F24F 5/00; B32B 27/06; B32B 5/18

(52) U.S. Cl. CPC E04C 2/525; E04B 1/942; F24D 3/14; B32B 2419/00; B32B 27/06; B32B 5/18; B32B 2307/304; F24F 5/0089

(57) ABSTRACT

In various example embodiments, a multi-layer building panel structure is described, comprising an interior and exterior panel layer, waterproof channel layers comprising adjacent parallel channels running from input and output manifolds fed by a remote fluid source. Each set of input and output manifolds may be configured to serve a zone of channels within the waterproof channel layers. Hot or cold fluid is pumped through the channel layers in order to heat or cool a space within a room of a building. The multi-layer building panel structure further provides structural support for a building and may be a wall, ceiling, or floor.

### BACKGROUND

### Field of the Invention

This invention generally relates to buildings and more particularly relates to heating and cooling a building.

### Background of the Invention

There are many ways to heat or cool a living space. The current art includes furnaces, boilers, heat pumps, gas-fired space heaters, electric space heaters, wood-burning and pellet stoves, fire places, ductless, and radiant heating. Radiant heating is advantageous because it allows for greater efficiency and zoning, is silent, and doesn't circulate allergens.

Current art radiant heat systems are normally installed in floors, but are also installed in walls and the ceiling. Current art most often uses PEX pipes or another type of pipe. They are placed throughout the floor, wall, or ceiling. Water then circulates through the pipes varying in temperature to either heat or cool the surrounding living area. These systems typically do not offer structural support for the buildings where they are installed. In addition, they represent a small portion of the surface area where they are installed. This can result in uneven heating, especially when objects are placed in front of or over top of the radiant heating/cooling system. For example, couches, bookshelves, and pictures or clocks that are hung on walls will impede the heating or cooling process.

Another limitation of existing systems is the fact that most radiant heating systems do not typically have zoning capabilities within the floor or wall structure that can be easily configured to fit the space being served. Even systems that include zoning are not able to either configure the zoning to fit multiple use scenarios, or change that configuration once the system has been installed. For example, a given space would have the zoning configured only for one specific use case. If the function of the space changes in the future, there would be no way to adjust the zoning within that specific space to fit the new use case. Having two different zoning configurations for heating vs cooling a space are also not possible with the normal “pre-set” known zoning configurations.

Other known radiant flooring systems are configured such that the pipes are installed and concrete is laid over top of them to comprise the floor of the building or living area. This makes the installation process cumbersome and expensive, and also impedes the heating or cooling process. A radiant heat system is needed that may comprise the floor itself, so that minimal material is placed between the fluid—the source of the heating or cooling—and the living area.

A system is needed that comprises the entire surface area of a wall, ceiling or floor. Such a system will allow for more efficient and consistent heating and cooling. A system that can be easily manufactured with the fluid pathway integrated within the wall, floor, or ceiling panel could potentially simplify the manufacturing process, and reduce the total system cost. A radiant heat system which offers structural support for the building is also needed. Embodiments disclosed herein may improve performance of radiant heat systems.

### SUMMARY

This invention has been developed in response to the present state of the art and, in particular, in response to the problems and needs in the art that have not yet been fully solved by currently available systems and methods. Features and advantages of different embodiments of the invention will become more fully apparent from the following description and appended claims, or may be learned by practice of the invention as set forth hereinafter.

Consistent with the foregoing, a structure for heating or cooling a living area that simultaneously provides structural support for the building is disclosed. Rather than have pipes embedded inside a wall, ceiling or floor structure, the structural material itself is configured with parallel channels running through the panel. These channels allow fluid flow throughout various layers of the structural panel for heating or cooling the space.

The structure includes: an interior layer and an exterior layer; one or more channel layers, sandwiched between the interior layer and the exterior layer, with the adjacent parallel waterproof channels divided into one or more zones. The channel layers further include adjacent waterproof channels running perpendicular to the parallel waterproof channels. Additional layers include: one or more structural layers adjacent the channel layers; a thermal insulation layer; three or more waterproof manifolds in communication with the parallel waterproof channels. A remote fluid source pumps fluid through the waterproof manifolds which then feed zones of channels fed by these manifolds. The minimum manifolds required are three which include: an input manifold feeding fluid into the channels, an output manifold for fluid leaving the channels, and an auxiliary manifold for control of the flow. This auxiliary manifold may be on the input or output side.

Each pair of manifolds (including one input manifold and one output manifold) serve one zone of channels.

In certain embodiments, the one or more channel layers include one or more materials and composites of: polycarbonate; acrylic; plastic; polystyrene; polypropylene; PVC; ABS; fiberglass; resin; crystalline materials; amorphous materials; organic materials; and synthetic materials.

In one embodiment, the remote fluid source is a liquid. In an embodiment, the liquid is at a temperature hot enough to radiantly heat a living area, and in another embodiment the liquid is at a temperature cool enough to radiantly cool the living area.

In an embodiment, the structural layers comprise integral structural members providing structural support for a building wherein it is placed. In an embodiment, air is inside the channels of one or more channel layers to insulate the living area.

In certain embodiments, at least one of the channel layers of the one or more channel layers are coated with heat reflective material comprising one or more of foil; paint; metamaterials; fabric and metal coatings.

The structure, in an embodiment, further comprises one or more pumps which pump the fluid into and out of the three or more manifolds and circulate the fluid throughout the waterproof channels within the one or more zones. In another embodiment, the structure further comprises a control system that increases the flow of fluid upon detection of a fire inside a room wherein the structure resides; wherein sensors alert the control system of the fire. In an embodiment, the sensors are integrated with the multi-layer building panel structure.

In certain embodiments, the channels within the one or more channel layers comprise extrusions of one or more of the shapes of: hexagon; octagon; triangle; quadrilateral; pentagon; heptagon; nonagon; decagon; shapes that enhance fluid flow; and shapes that facilitate the manufacturing of the channels.

In another embodiment, the thermal insulation layer comprises one or more materials of a foam board, rigid foam, aluminum foil, heat reflective material, and insulating material. In an embodiment, the one or more structural layers reflect heat by one or more of the following methods: coated with a heat reflective material; is reflective itself; has a coating on it that is reflective; and a reflective film adhesively attached.

In certain embodiments, there are one or more openings between two or more adjacent layers allowing the fluid to flow between the two or more adjacent layers. In certain embodiments, the multi-layer building panel structure is an interior wall, exterior wall, floor, or ceiling.

In an embodiment, one or more layers of the multi-layer building panel structure are coated with metamaterials comprising: glass-polymer hybrid materials with one or more properties of capturing heat; reflecting heat; shedding heat from the metamaterial; conducting heat; and transmitting heat.

One or more of each layer of the multi-layer building panel structure is adhesively attached to another layer, in an embodiment.

In an embodiment, the structural layer is constructed of one or more materials including composites of: polycarbonate; acrylic; plastic; polystyrene; polypropylene; PVC; ABS; fiberglass; resin; crystalline materials; amorphous materials; organic materials; synthetic materials; steel; stainless steel; copper; aluminum; titanium; alloys and metal.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is an isometric section view of a multi-layer building panel structure, according to an embodiment.

FIG. 2 is an isometric section view of certain sections of the structure, according to an embodiment.

FIG. 3 is a section view of the multi-layer building panel structure illustrating an example floor embodiment.

FIG. 4 is an isometric view of a room with a section view of a multi-layer building panel wall structure 110 next to it, according to an embodiment.

FIG. 5 is an isometric view of a room with a section view of a multi-layer building panel floor structure, according to an embodiment.

FIG. 6 is an isometric view of the structure with an extended structural layer, according to an embodiment.

FIG. 7 is a flow diagram showing the structure connected to a heating and cooling system, according to an embodiment.

FIGS. 8A, 8B and 8C are example embodiments of channels of various extruded shapes, according to various embodiments.

FIG. 9 is an isometric view of a multi-layer building panel structure illustrating how fluid flows thru the channel layers, according to an embodiment.

FIG. 10 is an isometric view of a multi-layer building panel structure illustrating how fluid flows thru the channel layers in another example embodiment.

FIG. 11 is a flow diagram of a multi-layer building panel structure illustrating how fluid flows thru the channel layers in an example embodiment.

FIG. 12 is a flow diagram of a multi-layer building panel structure illustrating how fluid flows thru the channel layers in another example embodiment.

FIG. 13 is another flow diagram of a multi-layer building panel structure illustrating how fluid flows thru the channel layers in one example embodiment.

FIG. 14 shows a room with a fire detector on the ceiling according to one embodiment.

### DETAILED DESCRIPTION OF THE DRAWINGS

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The liquid that flows through the waterproof channel layer may be water or any other hydronic fluid which includes oil.

There are many existing radiant heating systems which use PEX pipe or other similar piping. The multi-layer building panel structure is advantageous because it uses the entire surface area of the wall, ceiling or floor structure to radiantly heat or cool a living area. This will allow for greater flexibility when individuals living in, renting, or using the living area would like to add furniture, decorations, clocks, paintings, light fixtures, book shelves, cabinets or other furniture to the living area. In pex pipe radiant heating systems, the listed furniture causes a lot of problems because when the pipes only cover a very small portion of the surface area. Using furniture then blocks a greater percentage of the heat or cooling.

The water or other hydronic fluid may be pumped from input manifolds to output manifolds. Each set of manifolds serve a zone of channels. Each of these zones may serve a specific purpose. For example, zones may be configured to serve areas in a room by dedicating specific zones above furniture along a wall in that room. Other areas may require more heating in the Winter than cooling in the Summer, and thus have a larger area covered by the heating zone of channels.

Another advantage of this structure is the ability to reconfigure the structure to adapt to changes of function or use of the living space after the original installation. By modifying or reconfiguring the manifolds, the channel zoning allows zones to either be increased or decreased to accommodate the required changes.

There are various shapes that the channels of the waterproof channels may be shaped into. the channels are parallel to one another and evenly spaced and cover the surface area of the wall, ceiling, or floor where they are installed. One special advantage of the waterproof channels when compared to current art radiant heating systems is the issue of a leak. Current art radiant heating systems are extremely costly to install and are most often laid in floors and covered with a layer of concrete. Not only does this inhibit the heating or cooling effects, but makes repair very expensive whenever there is a leak in the pipes. the only option when there is a leak is to remove the concrete and repair the individual pipe that is the source of the problem. In contrast, in the multi-layer building panel structure, the channels through which the liquid flows are in communication with one another. That is to say, when there is a leak or a break in one of the channels, the liquid will flow into the channel adjacent to it and not out into the wall (which could cause molding, deterioration) thus small leaks in the multi-layer building panel structure do not require reparation. This also makes the multi-layer building panel structure less expensive to maintain than current art radiant heating and cooling systems.

The multi-layer building panel structure may be used as an exterior or interior wall or ceiling. In various embodiments, the thermal insulating layer is designed to direct the heat into the room that the waterproof channel layer is nearest. The channel layer perpendicular to the waterproof channel layer also contributes to directing the heat towards the intended room. This way, heat does not escape into a room or outdoor area behind the multi-layer building panel structure. By using a thermal insulating layer, owners of a multi-layer building panel structure can also use zoning, that is they can heat specific rooms that they need to without losing a lot of heat into surrounding rooms an insulating layer may be a foam board. The foam board is also useful in its ability to dampen sound traveling through rooms. It will help to control noise from traveling from room to room. The channel layer perpendicular to the waterproof channel layer can also provide the insulation necessary to direct the heat into the living area.

The structural layer may also contribute to insulating. In the preferred embodiment, the structural layer is made from a metal that has the natural attribute of being reflective to direct heat into the living area. In another embodiment, the metal sheet layer has a reflective coating so that the desired effect is still achieved. Another embodiment includes a reflective material being placed over the structural layer which has reflective properties and will also direct the heat into the living area.

There are a number of ways to heat fluid in a building. Any current fluid heating system will work with the multi-layer building panel structure. The hydronic fluid is pumped from the heating system to the upper or lower manifold. When the hydronic fluid exits the upper or lower manifold it is returned to the central water heating system and reheated or cooled to be circulated through the system again. Depending on the building type wherein the multi-layer building panel structure is installed, one central fluid heating and cooling system may be preferred over another.

the multi-layer building panel structure layers may be different than the order presented in various embodiments throughout the description contained herein. There are several embodiments that may be preferred depending on whether the multi layer wall structure is used as a ceiling, wall, or floor. The structural layer provides strength in addition to the sheer strength that is generated by the waterproof channel layer being perpendicular to the second channel layer. When the structure is used as a floor, the structural layer will be thicker to increase the maximum load bearing. The multi-layer building panel structure as a floor will need to support more weight at any time because of furniture and a varying number of people in the room. The wall and ceiling will not need to bear that load. Additional sheer and loading strength is achieved by structurally or adhesively connecting vertical channel layers with adjacent horizontal channel layers. Many examples of this are shown both in these written specifications and drawings contained herein.

These features and advantages of the embodiments will become more fully apparent from the following description and appended claims, or may be learned by the practice of embodiments as set forth hereinafter.

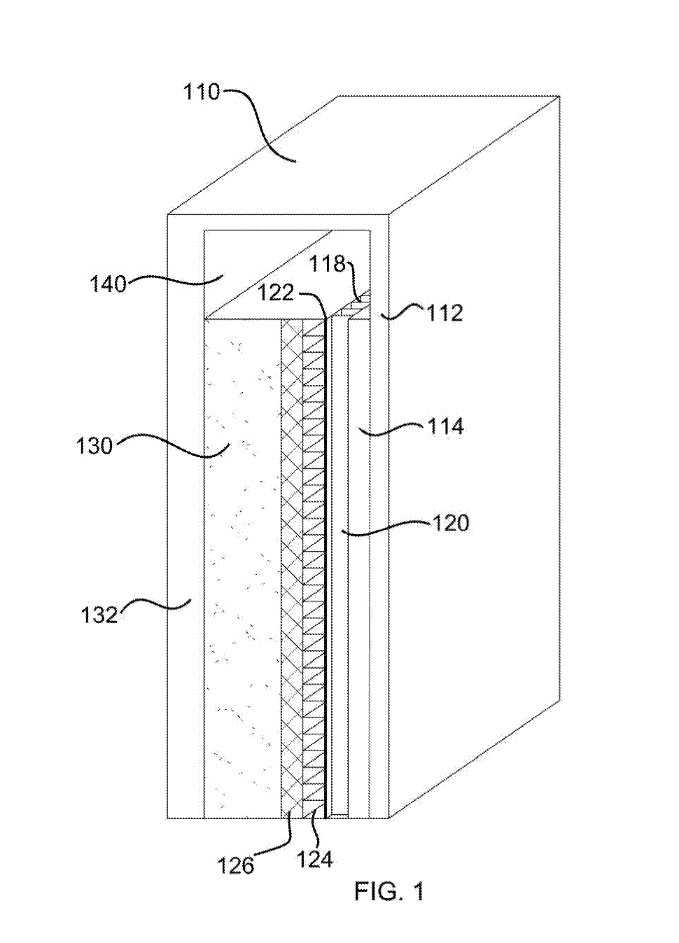

FIG. 1 is an isometric section view of a multi-layer building panel structure. The multi-layer building panel structure 110 is shown with an interior wall layer 112 facing the interior space of the area to be heated or cooled. In certain embodiments, a metamaterial 114 is placed between the waterproof channel layer 120 and the interior layer 112. The metamaterial 114 enhances the heat transfer from the waterproof channel layer 120 to the area to be heated or cooled. The vertical channels 118 open into the manifold to allow fluid to flow from the manifold into the channels. In one embodiment, fluid flows from the manifold 140 and through the channels 118.

In the embodiment shown in FIG. 1, the structural layer 126 is between a channel layer 124 and a thermal insulation layer 130. In this embodiment, the insulation also insulates the upper and lower manifolds. As shown in this embodiment, the waterproof channel layer 118 is coated with a heat reflective material 122. An outer layer 132 is shown facing the exterior of the building in certain embodiments. In other embodiments, the outer layer 132 is facing another room inside a building. In this case, the structure 110 is an interior wall, and the heating or cooling is only required in the room it is facing. This allows each wall structure to serve individual rooms both within the interior space of the building, and where the wall structure is an exterior wall. An advantage of this configuration is that the heating and cooling of each room or area within the building that has a multi-layer building panel structure can be controlled separately. This provides more control by allowing occupants of each individual room or space within the building to be able to adjust the temperature settings of the wall structure that serves their own area.

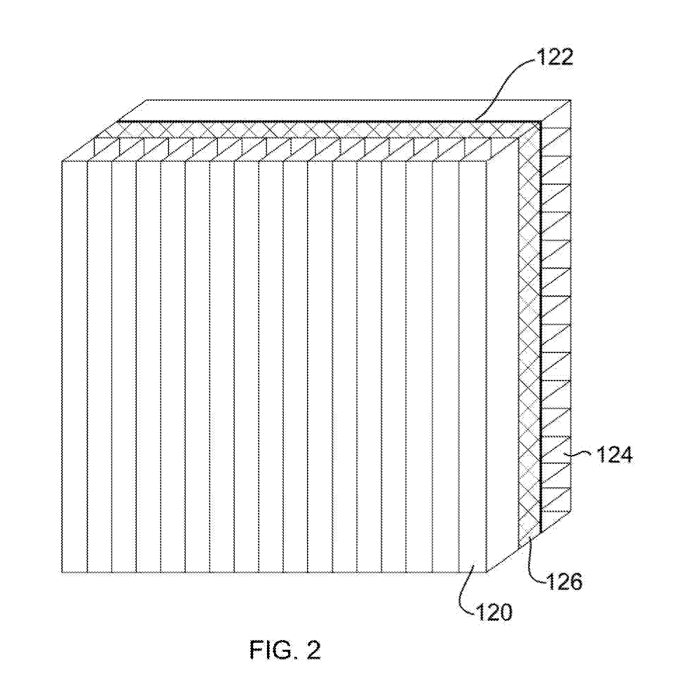

FIG. 2 is an isometric section view of certain sections of the structure showing the structural layer 126 in between the waterproof channel layer 120 and perpendicular channel layer 124. In this embodiment, the structural support layer is facing the waterproof channel layer and is coated with heat reflecting material 122.

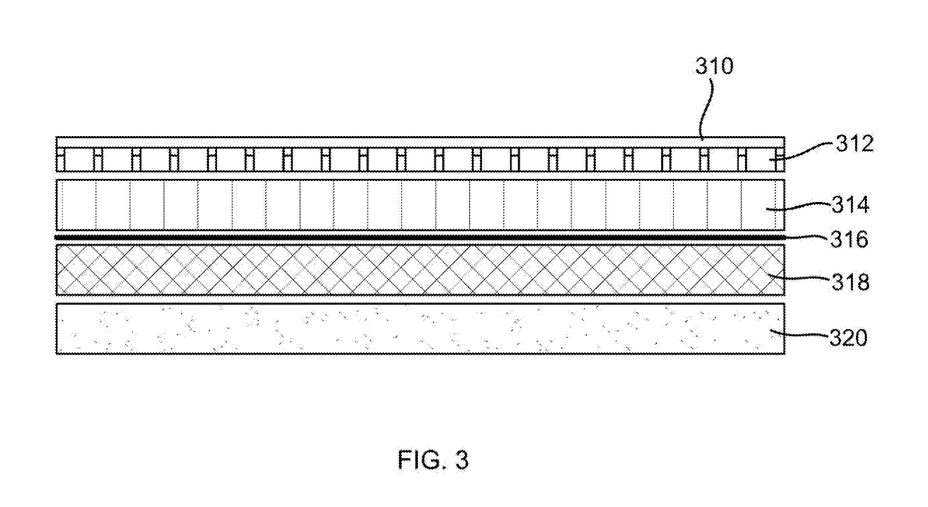

FIG. 3 is a section view of the multi-layer building panel structure illustrating an example floor embodiment. The top surface 310 is a laminate flooring material on top of a rubber mat 312. Heating generated by fluid flowing through channel layer 314 penetrates the laminate flooring 310 to heat the room above. Reflective material 316 directs the heat upwards and into the living area above the structure. Structural support layer 318 comprises structural elements that support the multi-layer building panel structure, and insulation layer 320 assures that heat is directed upwards towards the living area above.

Other embodiments may consist of a concrete floor 312 with tile 310 on top of the structure. In this embodiment there are five layers, however, additional layers may be required for specific applications. This figure is not intended to restrict the multi-layer building panel structure to only this number of layers. Nor is it intended to restrict it to the use of materials identified in this description.

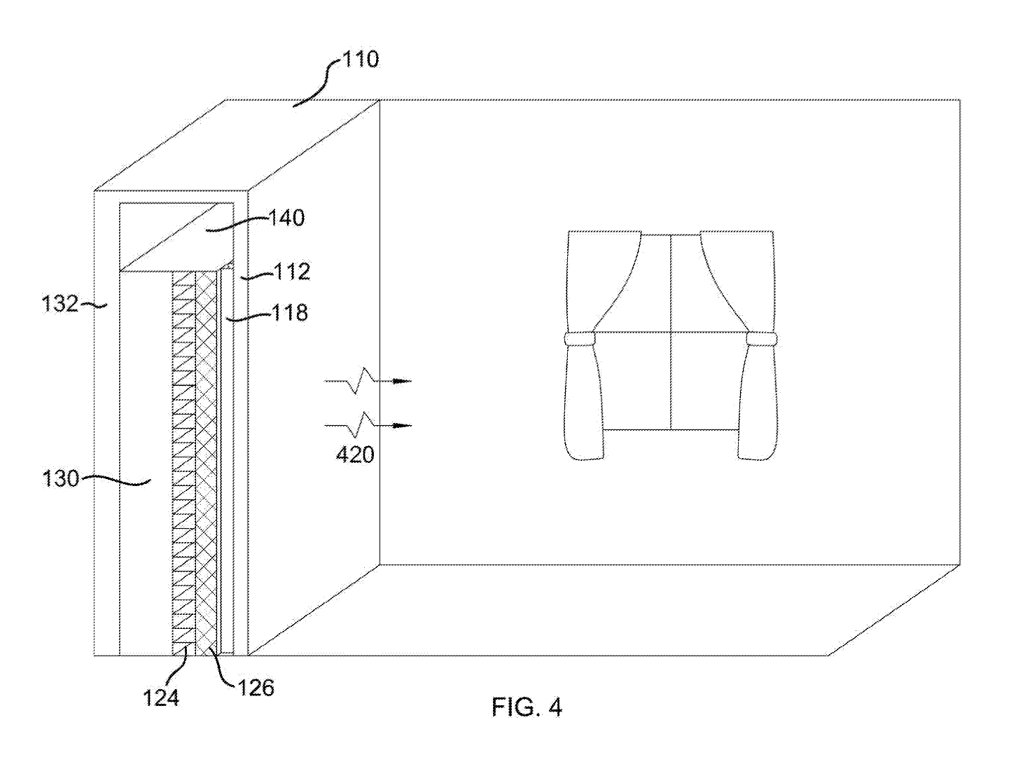

FIG. 4 is an isometric view of a room with a section view of a multi-layer building panel wall structure 110 next to it. Manifold 140 is shown, along with insulation layer 130 and outer layer 132. Structural layer 126 is shown adjacent to horizontal channel layer 124. The heat 420 from heated fluid flowing through waterproof channel layer 118 penetrates the interior wall layer 112 and extends into the room. In certain embodiments, the interior wall layer 112 allows heat to flow thru the wall material into the room. In an embodiment, the interior layer 112 further is sound dampening.

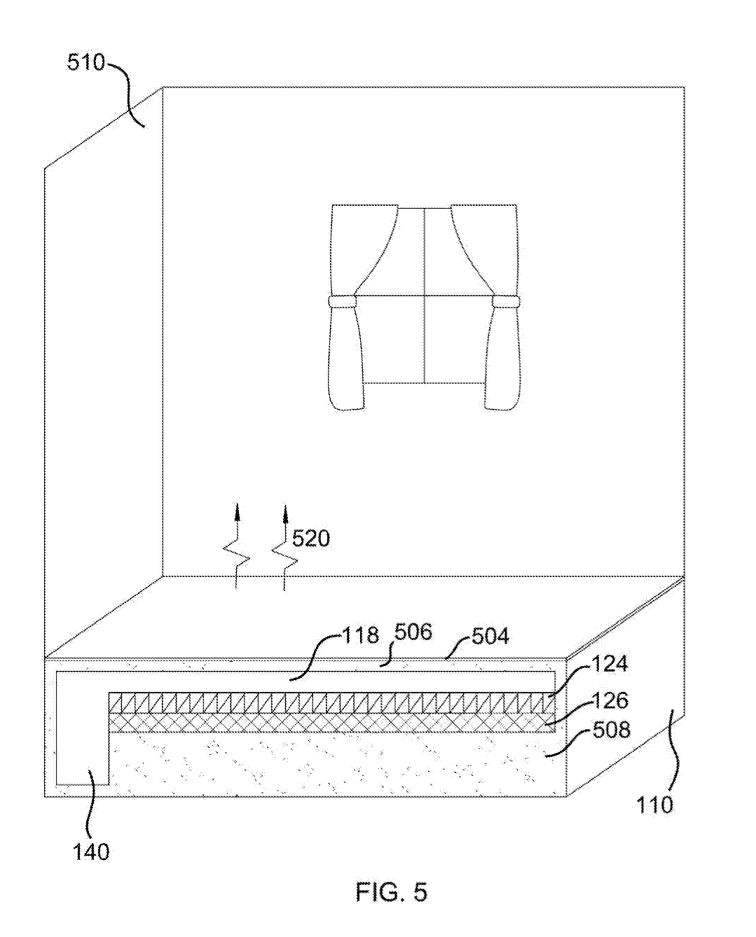

FIG. 5 is an isometric view of a room with a section view of a multi-layer building panel floor structure 110. Manifold 140 is shown, along with insulation layer 508, structural layer 126 and channel layer 124. The heat 520 from heated fluid flowing through waterproof channel layer 118 penetrates the interior floor layer 506 and laminate flooring 504, and extends into the room.

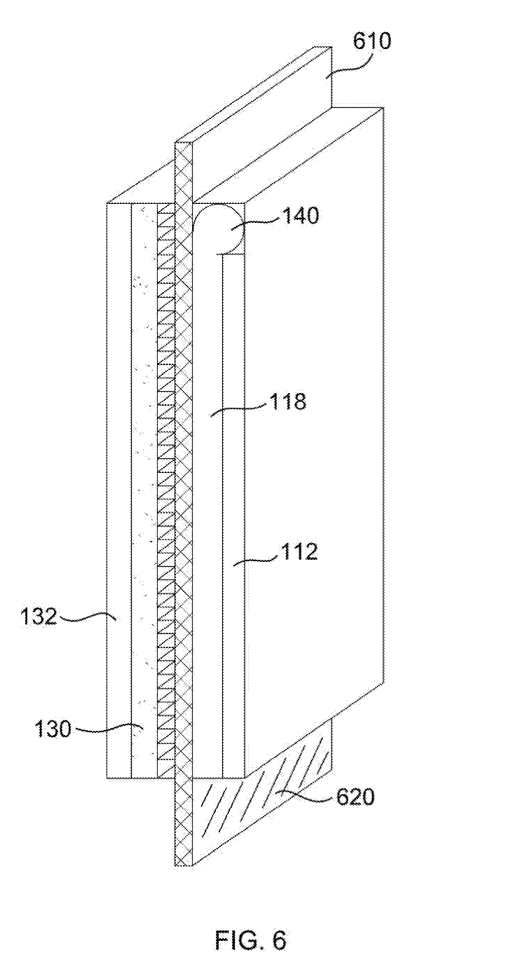

FIG. 6 is an isometric view of the structure with an extended structural layer 610. In this embodiment, the structural layer 610 extends beyond the other layers. This allows the structure to be structurally attached to adjacent structural members such as adjacent walls, floors or ceiling structures. Thermal insulation layer 130, interior wall layer 112, and outer layer 132 are shown. In this embodiment, manifold 140 is cylindrical in shape, and may be a pipe that allows fluid flow into the waterproof channel layer 118. Reflective surface 620 reflects the heat towards the living area to be heated.

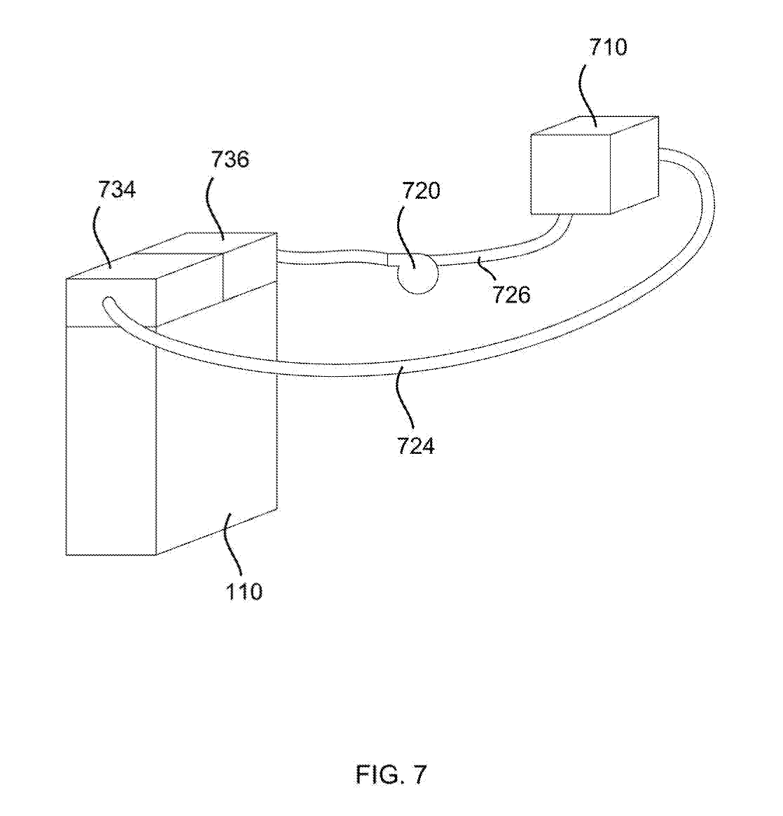

FIG. 7 is a flow diagram showing the structure 110 connected to a heating and cooling system 710. Pump 720 pumps fluid from the heating and cooling system 710 via supply piping 726 into input manifold 736. The fluid flows throughout the zone of waterproof channels and returns to the output manifold 734. The fluid then flows via the return piping 724 back to the heating and cooling system 710.

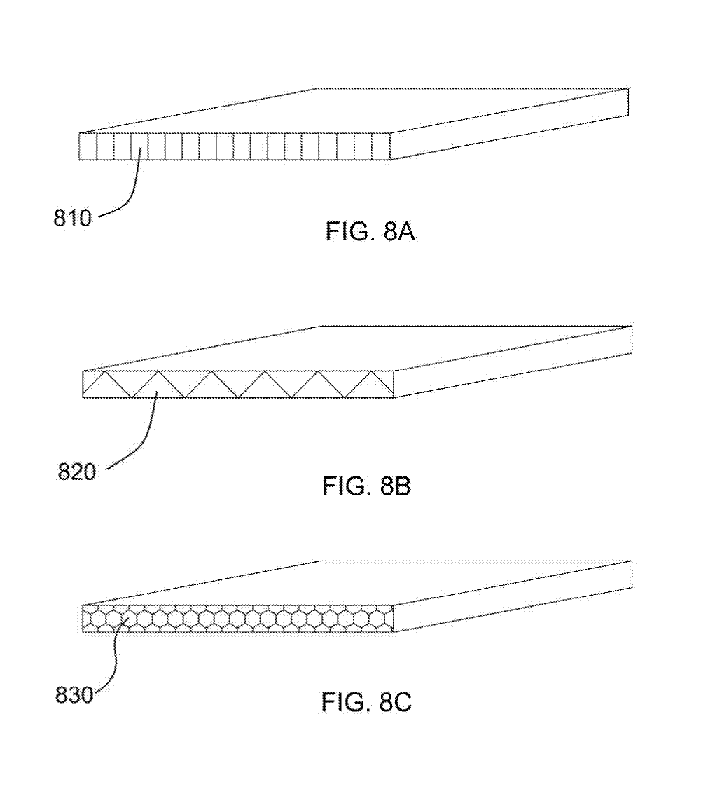

FIGS. 8A, 8B and 8C are example embodiments of channels of various extruded shapes. FIG. 8A shows square shaped channels 810, FIG. 8B shows triangular shaped channels 820, and FIG. 8C shows honeycomb shaped channels 830.

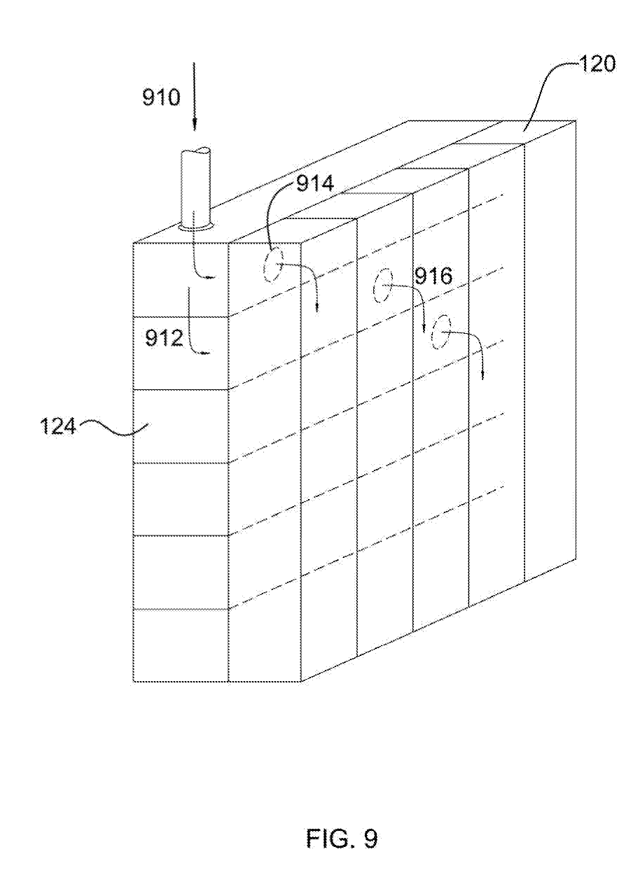

FIG. 9 is an isometric view of a multi-layer building panel structure illustrating how fluid flows thru the channel layers. Fluid 910 enters supply piping into horizontal channel layer 124. The fluid then flows 912 towards openings 914 between the horizontal channel layer and the vertical waterproof channel layer 120. Fluid flows down 916 towards the lower channels. In this embodiment, the horizontal channel layer is also waterproof, and serves as a pathway for the fluid to flow across the series of vertical waterproof channels. This allows for unique flow patterns to be configured as required. For certain applications, it may be advantageous to have the fluid flowing both up the vertical channels and down adjacent vertical channels.

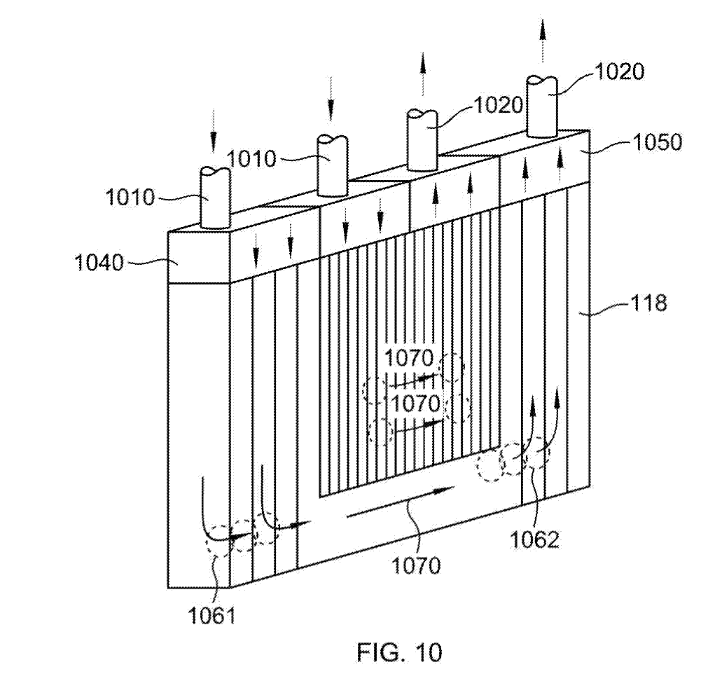

FIG. 10 is an isometric view of a multi-layer building panel structure illustrating how fluid flows thru the channel layers in another example embodiment. Arrows are showing fluid flow direction. Fluid enters supply piping 1010 entering input manifolds 1040, then flows down into vertical channels 118. Openings 1061 allow the fluid to flow into adjacent horizontal channels across 1070 to openings 1062 and into and up vertical channels 118 to output manifolds 1050. Openings 1070 allow fluid to flow between input and output vertical channels 118 as shown. Fluid then flows out the output piping 1020 and returns to the pumps.

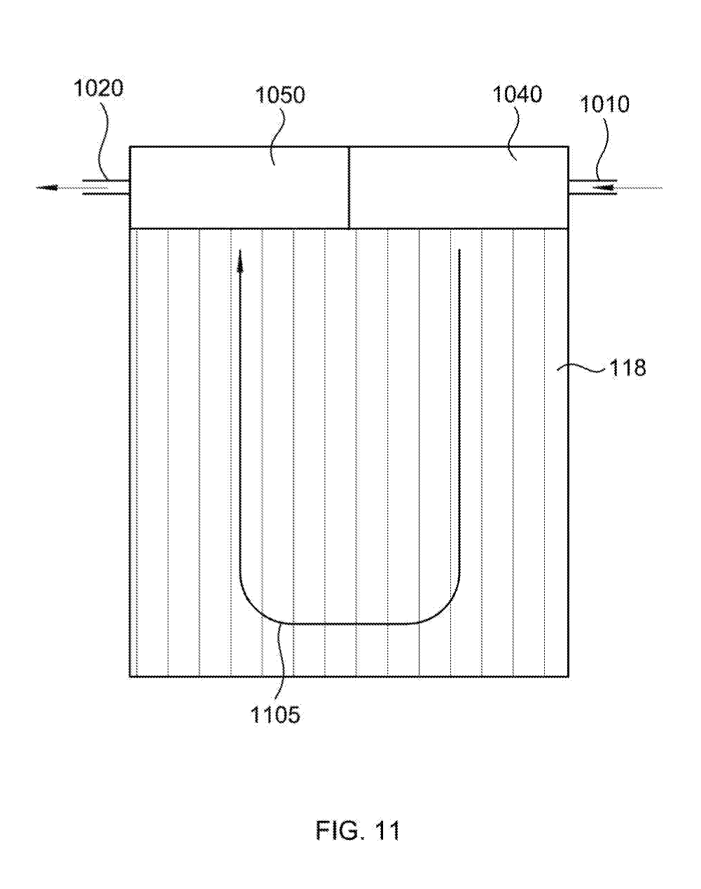

FIG. 11 is a flow diagram of a multi-layer building panel structure illustrating how fluid flows thru the channel layers in an example embodiment. Arrows are showing fluid flow direction. Fluid enters supply piping 1010 entering input manifold 1040, then flows down into vertical channels 118. The fluid flows through openings and across 1105 to adjacent vertical channels and back up to output manifold 1050. Fluid then flows out the output manifold 1050 and through output piping 1020 and returns to the pumps.

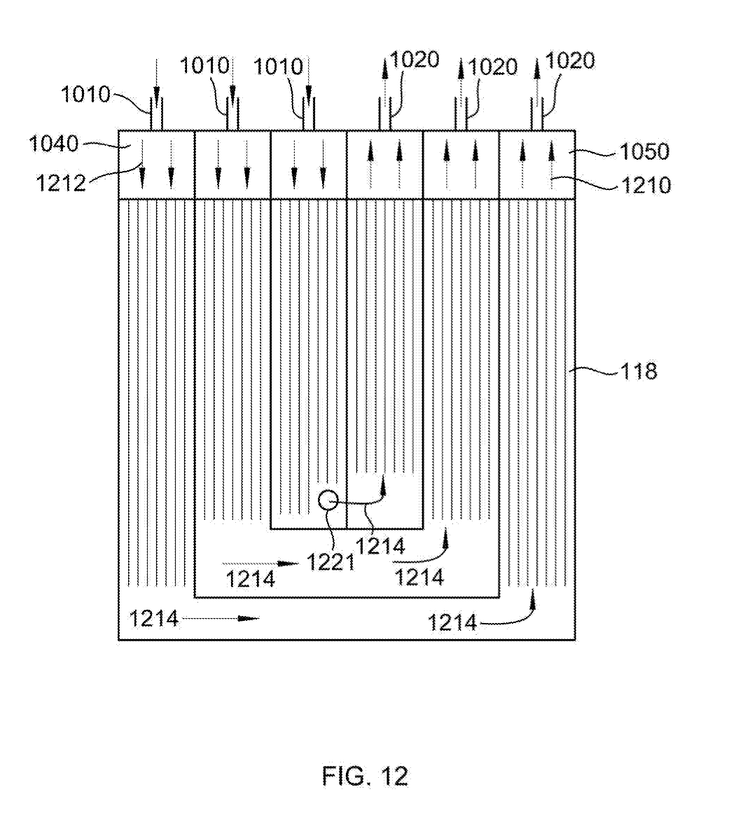

FIG. 12 is a flow diagram of a multi-layer building panel structure illustrating how fluid flows thru the channel layers in another example embodiment. Arrows are showing fluid flow direction. Fluid enters supply piping 1010 entering input manifolds 1040, then flows down 1212 into vertical channels 118. The fluid flows through openings 1221 and across 1214 to vertical channels and back up 1210 thru output manifolds 1050. Fluid then flows out the output manifolds 1050 and through output piping 1020 and returns to the pumps. This embodiment shows a structure with 3 input manifolds and 3 output manifolds.

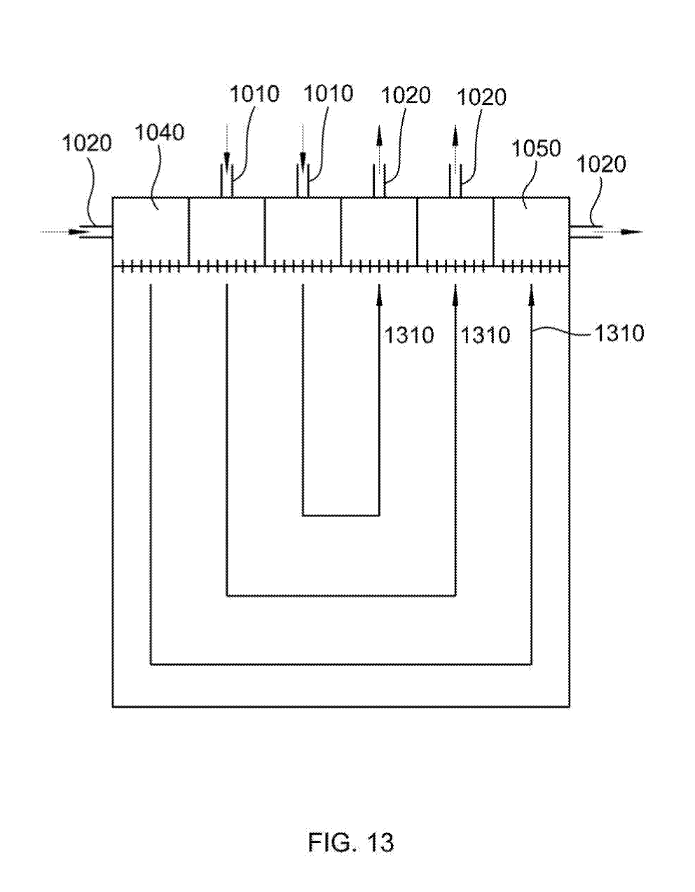

FIG. 13 is a flow diagram of a multi-layer building panel structure illustrating how fluid flows thru the channel layers in an example embodiment. Arrows are showing fluid flow direction. Fluid enters supply piping 1010 entering input manifolds 1040. Arrow pathways 1310 show the flow of fluid through each zone of channels. Fluid then flows out the output manifolds 1050 and through output piping 1020 and returns to the pumps.

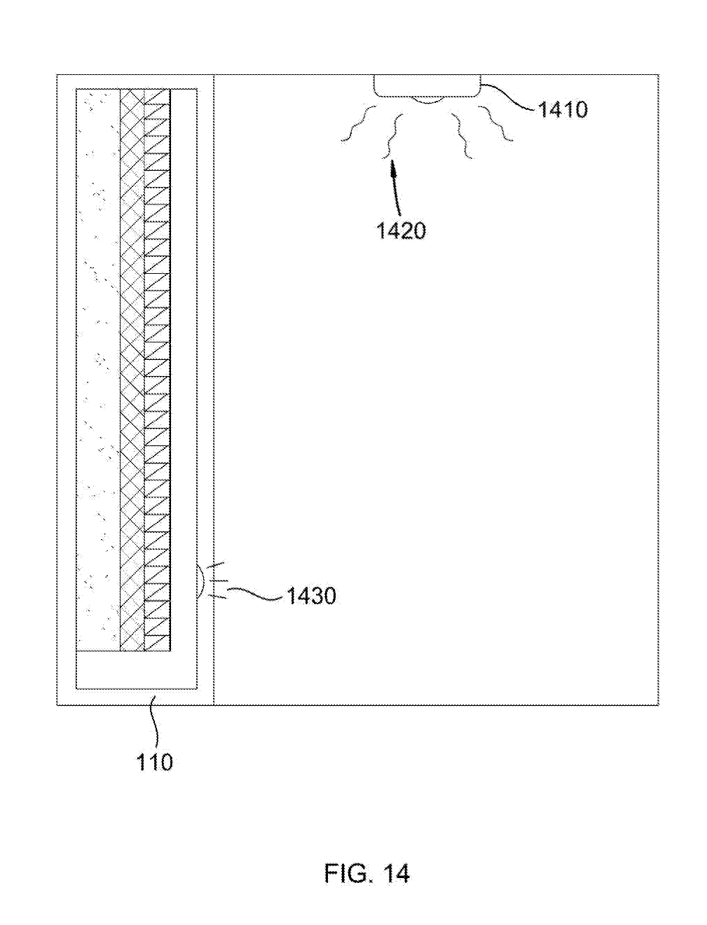

FIG. 14 shows a room with a fire detector on the ceiling according to one embodiment. Fire alarm system device 1410 may be a smoke detector, fire detector or other sensor tied to a fire alarm system. When smoke 1420 or fire is detected, the fire alarm system is notified. The control system of the multi-layer building panel structure 110 is notified of the fire by the fire alarm system so that the fluid flow may be increased in order to lower the surface temperature of the interior layer of the panel structure 110. In another embodiment, fire sensor 1430 is embedded or mounted to the panel structure 110.

Regarding the structural layer materials, wherein sheet metal is used for the structural layer, fabrication applies to sheets comprising SPCC, SHCC, SECC, SGCC, copper plates, aluminum plate(6061,6063,5052,1020, etc), aluminum extrusion and stainless steel. Various materials with different specifications may be utilized as follows: Steel plate cold-rolled (SPCC). Mainly used for part need painted or electro-plating, thickness usually no more than 3.2 mm; Hot rolled steel (SHCC). T≥3.0 mm, treated with spraying or electro plating as SPCC; Electro or Galvanized steel (SECC/SGCC). SECC includes N and P type; Copper plate. Mainly applied for electricity conducting function, surface treated with chrome or nickel plating, or without any finish; Aluminum plate. Usually treated with chromate, anodize (conductive anodizing or chemical anodizing), may be silver or nickel plated; Aluminum extrusion are with complex structure from side view, its surface can be treated as what aluminum plates do; and stainless steel sheet.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A multi-layer building panel structure, comprising:
an interior layer and an exterior layer;
one or more channel layers, disposed intermediate the interior layer and the exterior layer, comprising adjacent parallel waterproof channels divided into one or more zones;
one or more structural layers adjacent the channel layers;
a thermal insulation layer;
three or more waterproof manifolds in communication with the parallel waterproof channels;
wherein the three or more waterproof manifolds and waterproof channels are in communication with a remote fluid source; and
wherein each manifold is in communication with selected parallel serving the one or more zones.

2. The structure of claim 1, wherein the one or more channel layers comprise one or more materials and composites of: polycarbonate; acrylic; plastic; polystyrene; polypropylene; PVC; ABS; fiberglass; resin; crystalline materials; amorphous materials; organic materials; and synthetic materials.

3. The structure of claim 1, wherein the remote fluid source is a liquid.

4. The structure of claim 3, wherein the liquid is at a temperature sufficient to heat a living area.

5. The structure of claim 3, wherein the liquid is at a temperature sufficient to cool the living area.

6. The structure of claim 1, wherein the one or more structural layers comprise integral structural members providing structural support for a building wherein the multi-layer building panel structure is placed.

7. The structure of claim 1, wherein air is in one or more channels of the one or more channel layers to insulate the living area.

8. The structure of claim 1, wherein at least one of the channel layers of the one or more channel layers are coated with heat reflective material comprising one or more of foil; paint; metamaterials; fabric and metal coatings.

9. The structure of claim 3, wherein the multi-layer building panel structure further comprises one or more pumps which pump the fluid into and out of the three or more manifolds and circulate the fluid throughout the waterproof channels within the one or more zones.

10. The structure of claim 9, wherein the structure further comprises a control system that increases the flow of fluid upon detection of a fire inside a room wherein the structure resides; wherein sensors alert the control system of the fire.

11. The structure of claim 10, wherein the sensors are integrated with the multi-layer building panel structure.

12. The structure of claim 1, wherein the channels within the one or more channel layers comprise extrusions of one or more of the shapes of: hexagon; octagon; triangle; quadrilateral; pentagon; heptagon; nonagon; decagon; shapes that enhance fluid flow; and shapes that facilitate the manufacturing of the channels.

13. The structure of claim 1, wherein the thermal insulation layer comprises one or more materials of a foam board, aluminum foil, heat reflective material, and insulating material.

14. The structure of claim 1, wherein the one or more structural layers reflect heat by one or more of the following methods: coated with a heat reflective material; is reflective itself; has a coating on it that is reflective; and a reflective film adhesively attached.

15. The structure of claim 1, wherein one or more openings between two or more of the channel layers allow communication of fluid between the two or more adjacent channel layers.

16. The structure of claim 1, wherein the multi-layer building panel structure is an interior wall, exterior wall, floor, or ceiling.

17. The structure of claim 1, wherein one or more layers of the multi-layer building panel structure are coated with metamaterials comprising: glass-polymer hybrid materials with one or more properties of capturing heat; reflecting heat; shedding heat from the metamaterial; conducting heat; and transmitting heat.

18. The structure of claim 1, wherein one or more of each layer of the multi-layer building panel structure is adhesively attached to another layer.

19. The structure of claim 1, wherein the structural layer comprises one or more materials and composites of: polycarbonate; acrylic; plastic; polystyrene; polypropylene; PVC; ABS; fiberglass; resin; crystalline materials; amorphous materials; organic materials; synthetic materials; steel; stainless steel; copper; aluminum; titanium; alloys and metal.

20. The structure of claim 1, wherein the channel layers are coated with a fluid sealing composition.
